(19) United States
(12) Patent Application Publication
(10) Pub. No.: US 2012/0221716 A1
(43) Pub. Date: Aug. 30, 2012

(54) Tracking Internet Usage In A Household

(75) Inventors: Omri HALEVI, Mazkeret Batya (IL); Gideon Hallside, Tel Aviv (IL); Dave Springer, Petah Tikva (IL)

(73) Assignee: MOBILE RESEARCH LABS LTD., HOD HASHARON (IL)

(21) Appl. No.: 13/405,454

(22) Filed: Feb. 27, 2012

Related U.S. Application Data
(60) Provisional application No. 61/447,018, filed on Feb. 26, 2011.

(51) Int. Cl. G06F 15/173

(52) U.S. Cl. 709/224

(57) ABSTRACT

Tracking Internet usage in a home network including multiple household computing devices connectible using a consumer premises router. An agent is installable in the consumer premises router. A monitor server operatively connects to the consumer premises router. The agent is operable to: capture a request originating from at least one of the household devices and to extract data from the request. The data may include an identifier of the household device initiating the request.

### CROSS REFERENCE TO RELATED APPLICATIONS

The present application claims priority from U.S. provisional application 61/447,018 filed Feb. 25, 2011 by the present inventors, the disclosures of which are included herein by reference.

### BACKGROUND

1. Technical Field

The present disclosure relates to tracking Internet usage.

2. Description of Related Art

As home networking continues to grow in popularity and capability and the plethora of connected devices increase, some market research companies may see a possible opportunity to improve the study of domestic online habits. Market research companies (MRC) may gather information about Internet usage of representative Internet consumers or panelists in order to provide insight regarding household Internet usage, patterns and behaviors.

Conventional data collection agents running on end-point hardware, such as personal computers for example, may track online activity of Internet users. The end-point hardware may be prone to obstruction by virus protection, firewalls and other security software. Often the data collection agent may have to be installed on the personal computer of the panelist and the data may be considered biased if the data collection agent cannot run on any operating system for example. Furthermore, existing methods for data collection may not cover data collection from other Internet devices, which may be used in the household, such as Wi-Fi Radios, iPods™, other Wi-Fi Internet users, or Internet gaming consoles, such as Wii™. Operating system porting may also generate additional overhead, data transmission. Data capture may be blocked and the agent/plug-in may need to be reset after each operating system upgrade. The issues caused by conventional data collection agents may tend to pile up at help-desk levels, resulting in onerous support sessions and frustrated panelists.

Thus, there is a need for and it would be advantageous to have a system and method to obtain data at a gateway level which may capture all of the household Internet devices at a point which is hardware and operating system independent.

### BRIEF SUMMARY

According to an aspect of the present disclosure there are provided various systems and methods for tracking Internet usage in a household or home network including multiple household computing device inter-connectible using a consumer premises router and a monitor server operatively connected to the consumer premises router. A request is captured which originates from at least one of the household devices. Data is extracted from the request. The data includes includes an identifier of the household device. The data is routed from the request to the monitor server and a report is generated including identification of the household device.

The data from the request may include a device media access control (MAC) address, a time-stamp, a device time zone, a device identifier, a household member identifier, a universal resource locator (URL), a media title from a real time streaming protocol (RTSP) stream, a destination and source Internet protocol (IP) address and/or port numbers.

The data extractable from the request may be stored in a data packet either in a header or a payload of the data packet.

A list may be provided of household members of the household. The household members may identify themselves when starting a new browser session. The report may include the identity of the individual household members.

The system either the monitor server or agent installed in the router may enable detection of a new device in the household by redirecting the new device to set up a new device profile thereby adding the new device to the list household devices.

Based on the report, redirection of a browser session in the household device may be performed by triggering from selectably either the monitor server or the router.

The request may be between two or more of the household devices and the identifiers of both the requesting device and the serving device may be extracted and reported.

Various systems are provided for tracking Internet usage in a home network including multiple household computing devices connectible using a consumer premises router. The system includes an agent installable in the consumer premises router, and a monitor server operatively connected to the consumer premises router. The agent is operable to: capture a request originating from at least one of the household devices, extract data from the request. The data includes an identifier of the household device initiating the request. The data from the request is routed to the monitor server. The monitor server is operable to generate a report including identification of the household device. The monitor server may be attached to the home network or attached over the Internet.

According to embodiments of the present invention there may be provided a computer readable medium encoded with processing instructions for causing a processor to execute methods as disclosed herein.

### BRIEF DESCRIPTION OF THE DRAWINGS

The invention is herein described, in a non-limiting manner, by way of example only, with reference to the accompanying drawings, wherein:

FIG. 1 shows a system, according to a feature of the present invention.

FIGS. 2, 3, 4 and 5 which are flow diagrams illustrating different features of the present invention.

The foregoing and/or other aspects will become apparent from the following detailed description when considered in conjunction with the accompanying drawing figures.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, flash disk, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a phone or Personal Digital Assistant “PDA”) where internal modules (such as a memory and processor) work together to perform operations on electronic data. While any computer system may be mobile, the term “mobile computer system” especially includes laptop computers, netbook computers, cellular telephones, smart phones, wireless telephones, personal digital assistants, portable computers with touch sensitive screens and the like. The term “mobile computer device” and “mobile computer system” are used herein interchangeably. The term “device” and “computer system” are used herein interchangeably. The term “device” as used herein includes wired and wirelessly connected computer systems.

In this description and in the following claims, a “network” is defined as any architecture where two or more computer systems may exchange data. The term “network” may include wide area network, Internet local area network, Intranet, wireless networks such as “Wi-fi”, virtual private networks, mobile access network using access point name (APN) and Internet. Exchanged data may be in the form of electrical signals that are meaningful to the two or more computer systems. When data is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

The term “server” as used herein refers to a computer system including a processor, data storage and a network adapter generally configured to provide a service over the computer network. A computer system which receives a service provided by the server may be known as a “client” computer system.

The indefinite articles “a”, “an” is used herein, such as “a processor”, “a server”, a “sample” have the meaning of “one or more” that is “one or more processors”, “one or more servers” and “one or more samples”.

By way of introduction, different embodiments of the present invention are directed to generate a report to include identification of a household device connected to a consumer premises equipment (CPE) router. The report may include the user or household member initiating and or receiving a request. Household members may identify themselves, new devices may be added, new users and respective user information may be added and survey events may be surveyed to gather further information from a user based on the user's Internet usage and type of device he/she is using.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

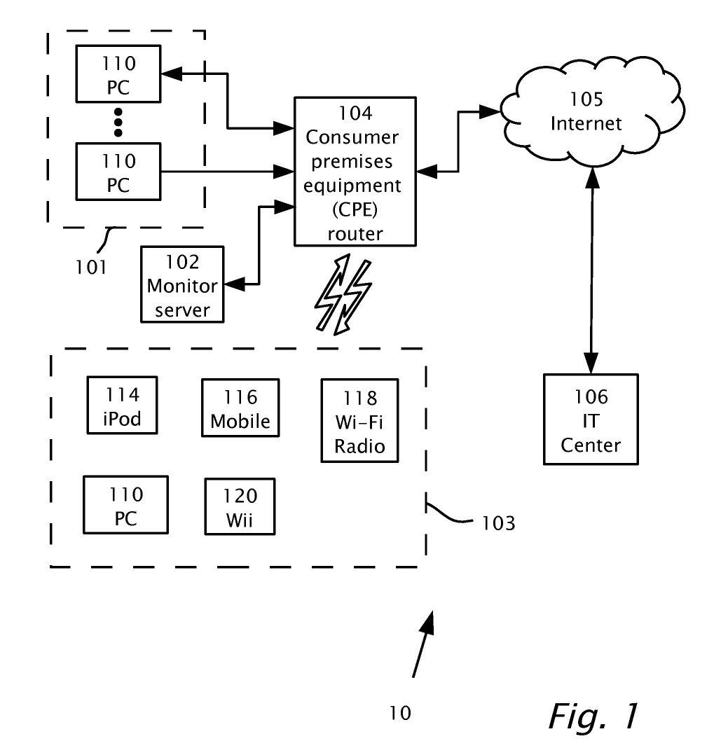

Reference is now made to FIG. 1 which shows a system 10, according to a feature of the present invention. System 10 includes a consumer premises equipment router 104 which may be located in a household or home network. Router 104 may be operatively attached to Internet 105, and hard wired via cabling for example to wired devices 101 and a monitor server 102. Devices 101 may include a number of personal computers 110 or printers for example. Router 104 may also be wirelessly attached to a number of wireless devices 103. Wireless devices 103 may typically include an iPod™ 114, WiFi radio 118, Wii™ games console 120, mobile phone 116, another personal computer 110 with wireless or an Internet tablet for example. An information technology (IT) center 106 may connect to router 104 via Internet 105.

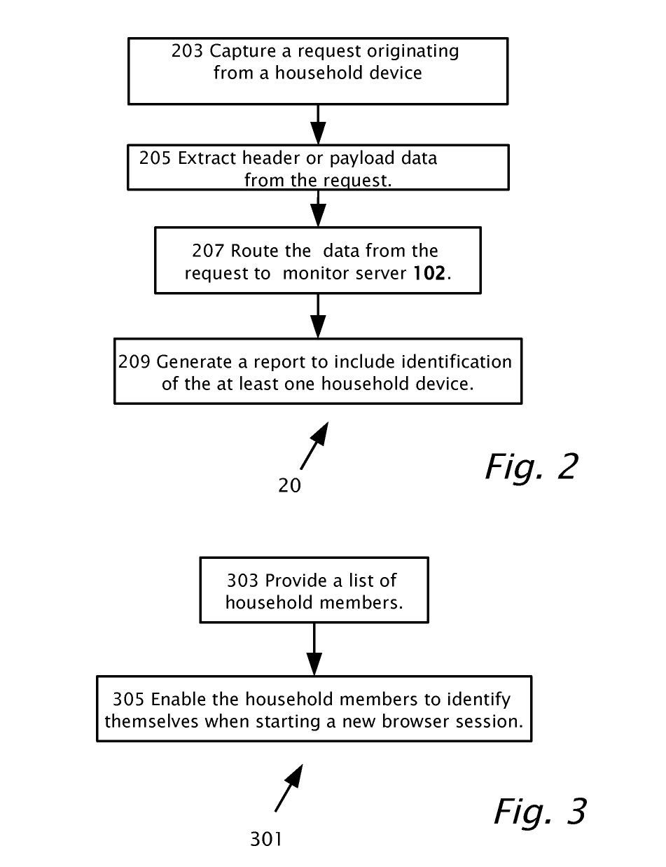

Reference is now made to FIG. 2 which shows a method 20, according to a feature of the present invention. In step 203, a request from at least one household device from wired devices 101 and/or wireless devices 103 may be captured using router 104. Firmware or agent in router 104 may implement an inspection of the packet data headers and for example, ascertain addressing protocols and port numbers. Further information may be continuously stored in storage of router 104 attributed to the individual household members and the household devices 101/103. Monitor server 102 alternatively or in addition may reside and be connected to Internet 105 outside the local network. In such cases, where monitor server 102 resides on Internet 105, the same monitor server 102 may serve multiple routers 104 installed in different home networks.

In step 205, the header data from the request may include; device media access control (MAC) address, time-stamp including the device time zone, device identifier (from the device profiles), household member identifier (browser sessions), universal resource locator (URL) (where applicable), extract media title from an real time streaming protocol (RTSP) stream, destination and source Internet protocol (IP) addresses, port numbers and protocols for example. In step 207, the header data from the request (step 203) may be routed to the monitor server 102.

Reports may be generated (step 209) (which include identification of at least one household device) from server 102 may be uploaded in practical real-time to IT center 106, in order to allow for the triggering of redirection requests based on recent browsing and online activity. Once a request record is uploaded from server 102, the request record may be deleted from the storage of router 104.

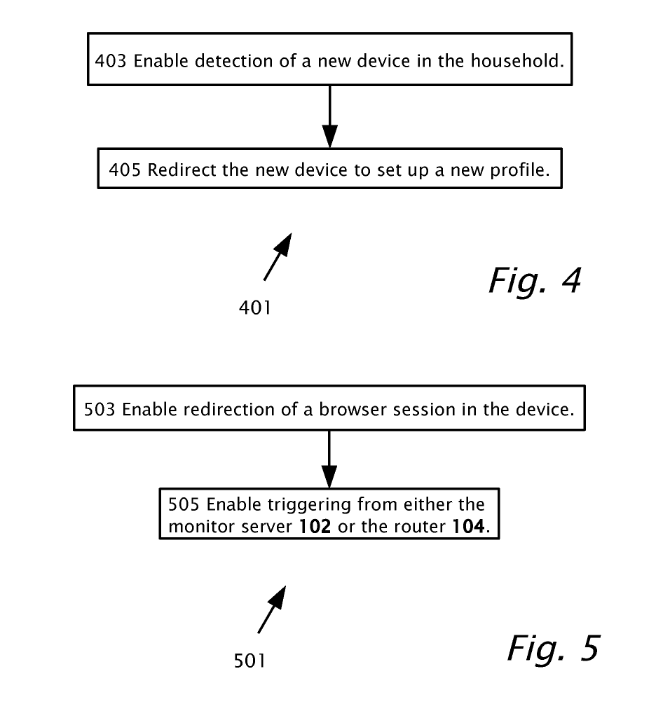

Reference is now made to FIGS. 3 and 4 which show methods 301 and 401 respectively, according to features of the present invention. Method 301 may apply to the time prior to the router 104 delivery to the household by the market research company or subsequent to installation of router 104. A list of household members is provided of the household on router 104 in step 303. Step 305 enables the household members to identify themselves when starting a new browser session, thereby allowing report step 209 to include the identity of the individual household members.

Changing and silently updating the list through the centralized management system of router 104 may be provided. The household members may have read-only access to a household roster stored in router 104. If users of Internet devices are not household members (either the device was detected (step 403) or tagged as a guest device through a discovery session or the users are guests using a shared device) the users may be not required to identify themselves from the roster. However, the users may be redirected (step 405) to an additional browser page where the users are required to provide additional information such as age and gender for example so as to set up a new profile. The new profile therefore, adds the new device to the already existing list of household devices.

Information about the new device 101/103 leading to the new device 101/103 being added may indicate if the new device 101/103 is a fixed device 101 or mobile device 103. For fixed devices 101 the household location may also included in the profile or if the device 101 is used by one or more of the household members.

Each time a device 101/103 previously identified as belonging to a guest appears on the home network, a user may be required to re-confirm the previous profile or update the existing profile data.

Once a device 101/103 is discovered it may receive the same internal IP address. Provision for additional fields in the profile are set by the market research company. Household device profiles are stored locally in router 104 and each time information is updated it is also written back to IT center 106.

Reference is now made to FIG. 5 which shows a method 501, according to an feature of the present invention. Step 503 may be based on report step 209 which may include the identification of at least one household device. The identification of at least one household device 101/103 may enable redirection of a browser session in at least one household device 104. The redirection of a browser session (step 503), may be triggered (step 505) from either monitor server 102 or router 104 to provide a survey event. The survey event may be transmitted through router 104 to Internet 105 and may be based on recent browsing activities uploaded to IT center 106. The recent browsing activity may have been a search about mobile phones for example and the survey event asks a number of questions with respect to mobile phones. Alternatively, monitor server 102 may have inbuilt surveys in firmware or provide external links to other survey events provided from Internet 105 and/or IT center 106 based on header data from request step 205. Surveys may also be updated and stored and survey events implemented in monitor server 102.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

We claim:

1. A method for tracking Internet usage in a household including a plurality of household devices connectible using a consumer premises router, a monitor server operatively connected to the consumer premises router over a network, the method comprising enabling the steps of:
capturing a request originating from at least one of the household devices;
extracting data from the request, wherein the data includes an identifier of the at least one of the household devices;
routing said data from the request to the monitor server; and
generating a report including identification of the at least one household device.

2. The method of claim 1, wherein data from the request is selected from the group consisting; a device media access control (MAC) address, a time-stamp, a device time zone, a device ID, a household member ID, a universal resource locator (URL), a media title from a real time streaming protocol (RTSP) stream, a destination and source Internet protocol (IP) address and port numbers.

3. The method of claim 1, wherein data from the request is stored in a data packet either in a header or a payload of the data packet.

4. The method of claim 1, further comprising:
providing a list of household members of the household;
enabling the household members to identify themselves when starting a new browser session;
wherein said report includes the identity of the individual household members.

5. The method of claim 1, further comprising:
enabling detection of a new device in the household;
redirecting said new device to set up a new device profile thereby adding said new device to the plurality of household devices.

6. The method of claim 1 further comprising:
based on the report, enabling redirection of a browser session in the household device by enabling triggering from selectably either the monitor server or the router.

7. The method of claim 1, wherein said request is between the household devices.

8. A system for tracking Internet usage in a home network including a plurality of household mobile computing devices connectible using a consumer premises router, the system comprising:
an agent installable in the consumer premises router; and
a monitor server operatively connected to the consumer premises router;
wherein the agent is operable to:
capture a request originating from at least one of the household devices;
extract data from the request, wherein the data includes an identifier of the at least one of the household devices;
route said data from the request to the monitor server; and
wherein the monitor server is operable to generate a report including identification of the at least one household device.

9. The system of claim 8, wherein data from the request is selected from the group consisting; a device media access control (MAC) address, a time-stamp, a device time zone, a device identifier, a household member identifier, a universal resource locator (URL), a media title from a real time streaming protocol (RTSP) stream, a destination and source Internet protocol (IP) address and port numbers.

10. The system of claim 8, wherein data from the request is extracted from at least one of header and a payload of the data packet.

11. The system of claim 8, further comprising:
providing a list of household members of the household;
enabling the household members to identify themselves when starting a new browser session;
wherein said report includes the identity of the individual household members.

12. The system of claim 8, further operable to:
enable detection of a new device in the household;
redirect said new device to set up a new device profile thereby adding said new device to the plurality of household devices.

13. The system of claim 8 further operable to:
based on the report, enable redirection of a browser session in the household device by enabling triggering from selectably either the monitor server or the router.

14. The system of claim 8, wherein said request is between the household devices.

15. The system of claim 8 wherein the monitor server is installable in the home network.

16. The system of claim 8 wherein the monitor server is operatively attached to the home network through the Internet.
